(19) United States
(12) Patent Application Publication
(10) Pub. No.: US 2013/0127286 A1
(43) Pub. Date: May 23, 2013

(54) CONTINUOUS STATOR WINDING HAVING A RECTANGULAR CROSS-SECTION AND METHOD

(71) Applicant: Mark A. Stephenson, Fairland, IN (US)

(72) Inventor: Mark A. Stephenson, Fairland, IN (US)

(73) Assignee: REMY TECHNOLOGIES, L.L.C., Pendleton, IN (US)

(21) Appl. No.: 13/298,866

(22) Filed: Nov. 17, 2011

(51) Int. Cl. H02K 3/28; H02K 15/02

(52) U.S. Cl. 310/179; 29/596

(57) ABSTRACT

A continuous stator winding includes a conductor having a rectangular cross-section, and a plurality of loops formed in the conductor. Each of the plurality of loops includes first and second substantially straight segments joined by at least one angled segment. A cross-over feature is formed in the at least one angled section. The cross-over feature includes a deformation formed in the conductor configured and disposed to nest with other conductors that form the stator winding.

### BACKGROUND OF THE INVENTION

Exemplary embodiments pertain to the art of electric machines and, more particularly, to an electric machine including a continuous stator winding having a rectangular cross-section.

Electric machines include stators that are wound with one or more conductors. The one or more conductors form a stator winding that is designed to impart or receive an electro-motive force from rotor windings to either power the electric machine in the case of an electric motor, or pass an electrical current to an external load in the case of a generator. In general, stator windings are formed with conductors having a circular cross-section or conductors having a rectangular cross-section. When forming a stator, the conductors are guided into slots formed in a stator core. As the stator winding is formed conductors will overlap one another. In order to reduce bulk, the stator is subjected to a compacting operation that urges the conductors against one another to form a more compact component.

### BRIEF DESCRIPTION OF THE INVENTION

Disclosed is a continuous stator winding including a conductor having a rectangular cross-section, and a plurality of loops formed in the conductor. Each of the plurality of loops includes first and second substantially straight segments joined by at least one angled segment. A cross-over feature is formed in the at least one angled section. The cross-over feature includes a deformation formed in the conductor configured and disposed to nest with other conductors that form the stator winding.

Also disclosed is an electric machine including a housing, a rotor rotatably supported in the housing, and a stator fixedly mounted relative to the stator. The stator includes a stator core having one or more continuous stator windings. The one or more continuous stator windings include a conductor having a rectangular cross-section, and a plurality of loops formed in the conductor. Each of the plurality of loops includes first and second substantially straight segments joined by at least one angled segment. A cross-over feature is formed in the at least one angled section. The cross-over feature includes a deformation formed in the conductor configured and disposed to nest with other conductors that form the stator winding.

Further disclosed is a method of forming a continuous stator winding having a rectangular cross-section. The method includes inserting a continuous conductor having a rectangular cross-section into a die, die forming the continuous conductor to establish a plurality of loops having first and second substantially straight segments joined by at least one angled segment, and die forming a cross-over feature in the at least one angled segment.

### BRIEF DESCRIPTION OF THE DRAWINGS

The following descriptions should not be considered limiting in any way. With reference to the accompanying drawings, like elements are numbered alike:

FIG. 1 depicts a partial cross-sectional view of an electric machine including a stator having a continuous stator winding in accordance with an exemplary embodiment;

FIG. 2 depicts a conductor having a rectangular cross-section undergoing a first forming step to form the continuous stator winding in accordance with an exemplary embodiment;

FIG. 3 depicts the conductor undergoing a second forming step to establish a cross-over feature of the continuous stator winding in accordance with the exemplary embodiment; and

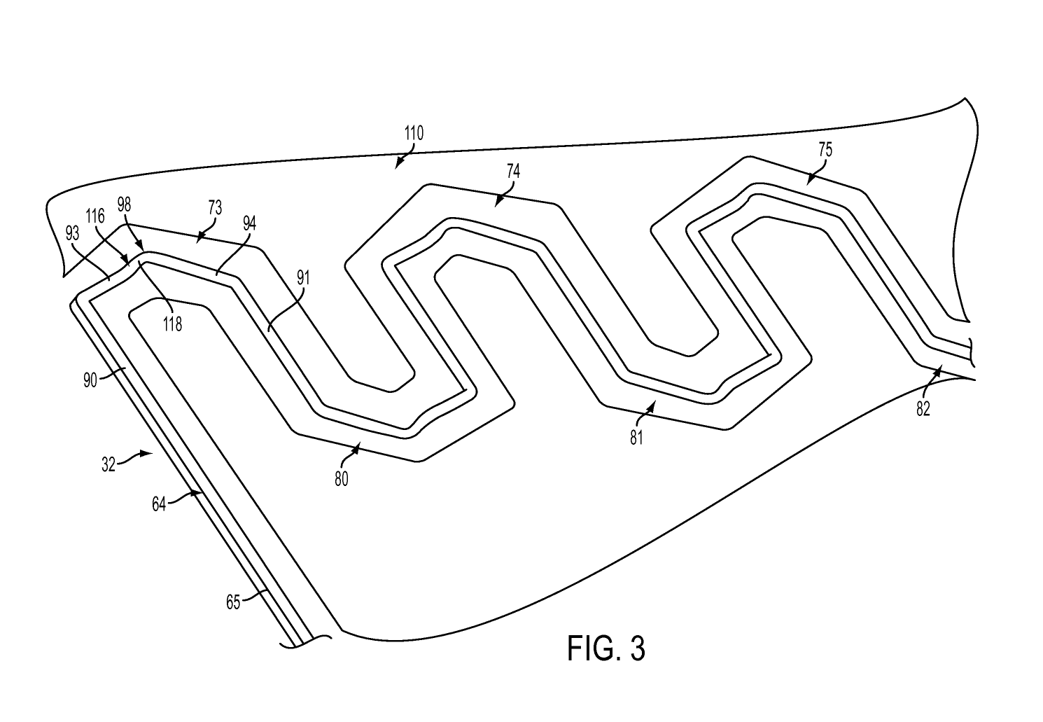

FIG. 4 is a partial perspective view of the stator and continuous stator winding in accordance with an exemplary embodiment.

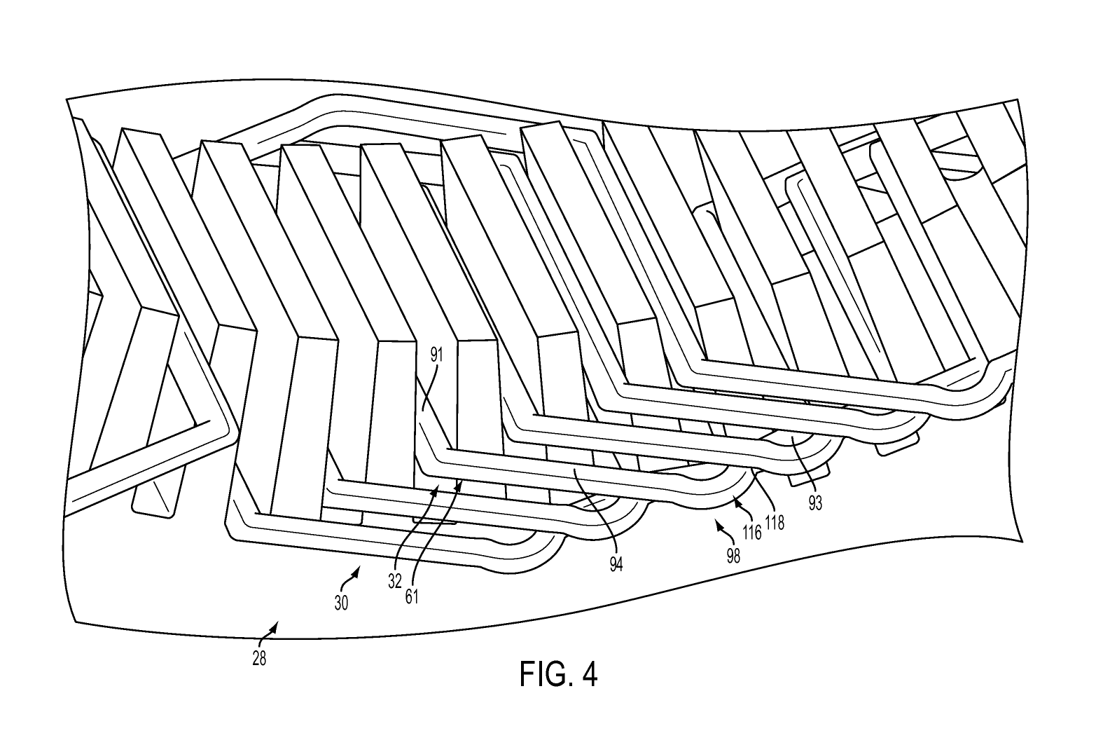

### DETAILED DESCRIPTION OF THE INVENTION

A detailed description of one or more embodiments of the disclosed apparatus and method are presented herein by way of exemplification and not limitation with reference to the Figures.

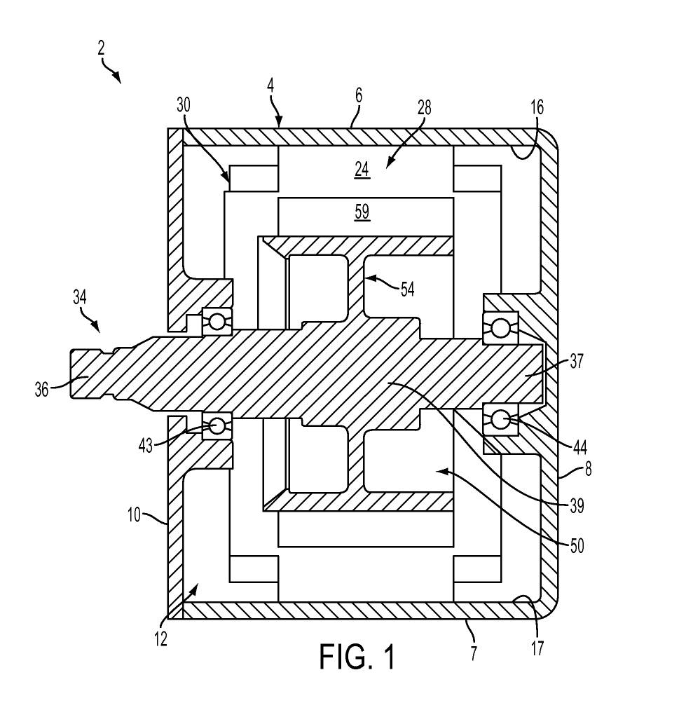

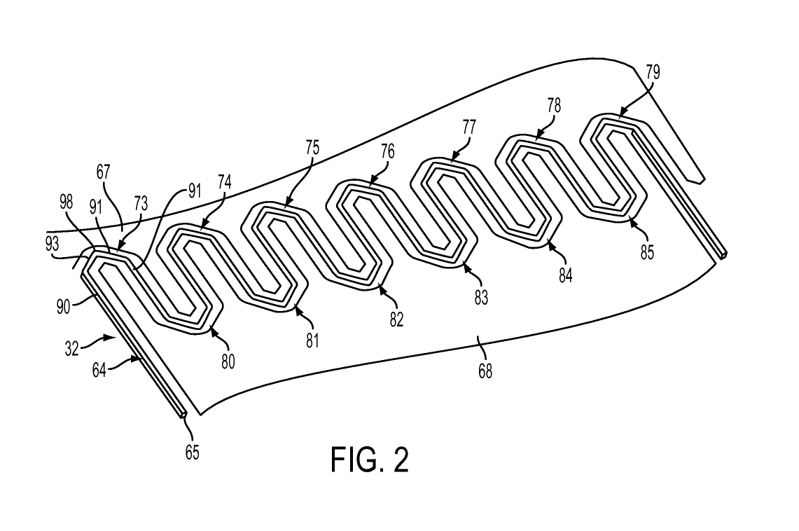

An electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes an inner surface 16 and second side wall 7 includes an inner surface 17. At this point it should be understood that housing 4 could also be constructed to include a single side wall having a continuous inner surface. Electric machine 2 is further shown to include a stator 24 arranged at inner surfaces 16 and 17 of first and second side walls 6 and 7. Stator 24 includes an annular stator core 28 which, as will be discussed more fully below, supports a plurality of stator windings 30. Stator windings 30 are formed from a plurality of discrete continuous stator winding elements, one of which is indicated at 32 in FIG. 2. As shown, continuous stator winding elements 32 are arranged in slot segments (not separately labeled) of stator core 28. As will be discussed more fully below, continuous stator winding element 32 nest with adjacent continuous stator winding elements (not separately labeled) to reduce an overall form factor for stator windings 30.

Electric machine 2 is also shown to include a shaft 34 rotatably supported within housing 4. Shaft 34 includes a first end 36 that extends to a second end 37 through an intermediate portion 39. First end 36 is rotatably supported relative to second end wall 10 through a first bearing 43 and second end 37 is rotatably supported relative to first end wall 8 through a second bearing 44. Shaft 34 supports a rotor assembly 50 that is rotatably mounted within housing 4. Rotor assembly 50 includes a rotor hub 54 that is fixed relative to intermediate portion 39, and a rotor lamination 59 that is configured to rotate relative to stator 24.

In accordance with an exemplary embodiment, continuous stator winding element 32 is formed from a conductor 64 having a rectangular cross-section 65. In accordance with one aspect of the exemplary embodiment, conductor 64 is die-formed between two die halves 67 and 68 to form a plurality of loops 73-85. Of course, it should be understood that loops 73-85 could be formed using a wide variety of forming processes. Also, it should be understood that the number of loops can vary. Regardless of the forming process employed, each loop 73-85 includes first and second substantially straight segments 90 and 91 joined by first and second angled segments 93 and 94 such as shown on loop 73. First and second angled segments 93 and 94 extend from corresponding ones of first and second substantially straight segments 90 and 91 and join at a juncture 98. As shown, while each loop 73-85 includes dedicated angled segments, substantially straight segments are shared by adjacent loops 73-85.

In further accordance with the exemplary embodiment, after forming the plurality of loops 73-85 conductor 64 is posited in a second die 110 that forms a cross-over feature 116 at each juncture 98. More specifically, cross-over feature 118 is created by a bend or twist 118 formed at each juncture 98 by second die 110. Cross-over feature 116 is sized and configured to nest with a portion of another one of stator windings 30. In this manner, cross-over feature 116 allows stator windings 30 to form a more compact assembly when installed in stator core 28. Thus, in contrast to prior art arrangements that physically compact stator windings following installation to the stator core, the exemplary embodiment provides stator windings that do not require compaction in order to form a desired stator geometry. Stator windings subjected to compaction or compression are generally unsuitable for high voltage application. The compaction or compression process can introduce points that allow higher voltages to jump across adjacent windings and cause a short circuit. A compact stator formed without a compaction step such as in accordance with the exemplary embodiment, is thus suitable for applications that employ higher voltages.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A continuous stator winding comprising:
a conductor having a rectangular cross-section;
a plurality of loops formed in the conductor, each of the plurality of loops including first and second substantially straight segments joined by at least one angled segment; and
a cross-over feature formed in the at least one angled section, the cross-over feature including a deformation formed in the conductor configured and disposed to nest with other conductors that form the stator winding.

2. The continuous stator winding according to claim 1, wherein the deformation comprises a twist formed in the at least one angled section.

3. The continuous stator winding according to claim 1, wherein the at least one angled segment includes a first angled segment extending from the first substantially straight segment and a second angled segment extending from the second substantially straight segment, the first angled segment joining the second angled segment to form a juncture.

4. The continuous stator winding according to claim 3, wherein the cross-over feature is formed at the juncture.

5. The continuous stator winding according to claim 4, wherein the cross-over feature comprises a twist formed at the juncture.

6. An electric machine comprising:
a housing;
a rotor rotatably supported in the housing; and
a stator fixedly mounted relative to the stator, the stator including a stator core having one or more continuous stator windings, the one or more continuous stator windings comprising:
a conductor having a rectangular cross-section;
a plurality of loops formed in the conductor, each of the plurality of loops including first and second substantially straight segments joined by at least one angled segment; and
a cross-over feature formed in the at least one angled section, the cross-over feature including a deformation formed in the conductor configured and disposed to nest with other conductors that form the stator winding.

7. The electric machine according to claim 6, wherein the deformation comprises a twist formed in the at least one angled section.

8. The electric machine according to claim 6, wherein the at least one angled segment includes a first angled segment extending from the first substantially straight segment and a second angled segment extending from the second substantially straight segment, the first angled segment joining the second angled segment to form a juncture.

9. The electric machine according to claim 8, wherein the cross-over feature is formed at the juncture.

10. The electric machine according to claim 9, wherein the cross-over feature comprises a twist formed at the juncture.

11. A method of forming a continuous stator winding having a rectangular cross-section, the method comprising:
inserting a continuous conductor having a rectangular cross-section into a die;
die forming the continuous conductor to establish a plurality of loops having first and second substantially straight segments joined by at least one angled segment; and
die forming a cross-over feature in the at least one angled segment.

12. The method of claim 11, wherein die forming the cross-over feature includes die forming a deformation in the at least one angled segment that is configured and disposed to nest with another stator winding.

13. The method of claim 11, wherein die forming the continuous conductor includes forming first and second angled segments that extend from the first and second substantially straight segments and join at a juncture.

14. The method of claim 13, wherein die forming the cross-over feature includes die forming a deformation in the juncture.

15. The method of claim 11, wherein die forming the cross-over feature includes forming a twist in the at least one angled segment.
